(19) United States
(12) Patent Application Publication
(10) Pub. No.: US 2010/0018507 A1
(43) Pub. Date: Jan. 28, 2010

(54) FUEL INTAKE FOR AN ENGINE

(76) Inventor: James Froese, Elmira (CA)

Correspondence Address: DIMOCK STRATTON LLP, 20 QUEEN STREET WEST, 32nd FLOOR, BOX 102, TORONTO, ON, M5H 3R3, CA

(21) Appl. No.: 12/178,073

(22) Filed: Jul. 23, 2008

(51) Int. Cl. F02M 31/14; F02G 5/00

(52) U.S. Cl. 123/545

(57) ABSTRACT

The two-stroke engine fuel intake connects a carburator with the intake port of a two-stroke engine, to homogenize substantially all of the fuel droplets in the fuel-air mixture. The intake tube is in thermal contact with the engine and uses the engine heat to heat the fuel-air mixture. Preferably an oil injection tube extends through the fuel intake tube and injects oil into the fuel-air mixture, heat from which vaporizes substantially all of the fuel-air mixture and assists with vaporizing the oil into the fuel-air mixture.

### FIELD OF THE INVENTION

This invention relates to gasoline engines. In particular, this invention relates to a fuel intake which increases the efficiency of a two stroke gasoline engine.

### BACKGROUND OF THE INVENTION

In two-stroke gasoline engines, the gasoline fuel is mixed with air in the carburetor and delivered to the cylinders. The fuel-air mixture is ignited in the cylinder and the energy used to provide the mechanical energy of the engine. Because of the inherent inefficiencies in the engine, the engine produces both mechanical energy and heat energy.

The carburetor is often connected to the engine via an intake manifold which communicates the fuel-air mixture from the carburetor to the engine. Often, a rubber boot is used between the engine and intake manifold to isolate the engine heat and vibration from the carburetor.

Atomized fuel contains small droplets of fuel mixed with air. Vaporized fuel contains the fuel in a gaseous state and mixed with air, a combination that usually provides superior burning properties and is more efficient in a two stroke engine.

However, delivering atomized fuel to the combustion chamber is beneficial to the cooling of the cylinder head as it absorbs heat from its surroundings as it is vaporized. Pre-heating of the atomized fuel also generally improves the burning properties of the engine.

If the fuel-air mixture enters the cylinder too hot, there is a tendency for the mixture to lose homogeneity, an effect that can negatively affect the burning of the fuel and therefore lower the efficiency of the engine.

There are several techniques known in the prior art to heat the incoming fuel-air mixture using secondary sources of heat. For example, U.S. Pat. No. 5,778,860 issued Jul. 14, 1998 to Garcia teaches the heating of a portion of the fuel using the ambient heat of the engine compartment. Garcia teaches heating the liquid fuel before it is atomized by the carburetor. This requires adjustments be made to the preheating when the external ambient temperature changes, such as operating the engine on hot summer days. In high outside temperatures, less preheating of the fuel is required as the incoming fuel is already partially warmed before entering the intake manifold. Using this design in cold climate conditions reduces its effectiveness because the temperature of the ambient engine compartment is cooler. This disadvantage is due to its indirect heating design, namely that heat from the engine has to heat the ambient air which in turn heats the incoming fuel-air mixture.

The elongated fuel bypass taught in U.S. Pat. No. 5,769,059 issued Jun. 23, 1998 to Wallace uses a bypass adjacent to the intake manifold to preheat the fuel mixture. It uses an elongated fuel air bypass of between three and twelve feet to vaporize the fuel air mixture, and beat from the ambient environment of the engine compartment to heat the fuel-air mixture passing through the bypass. Because the design relies on heat from the ambient environment, it uses a large surface requiring both length and a large outside diameter. This is expensive, cumbersome and requires additional compensating devices to compensate for its flaws. With the large amount of surface area, the design is subject to variations in the ambient temperature. In hot weather, it may overheat the fuel mixture. In cold weather, the elongated bypass will transfer a lot of heat through the large surface, requiring a heavier wall thickness in the bypass or a heat exchanger to improving the heating of the fuel mixture. After air supply, an injection system and a backfire safety device are other compensating devices taught for this design to work properly. Further, this design is suitable only for a four stroke engine, as its use on a two stroke engine may impair the scavenging of exhaust in the combustion chamber because of the turbulence introduced in the bypass to increase the mixing of the fuel-air mixture.

### BRIEF DESCRIPTION OF THE DRAWINGS

In drawings which illustrate by way of example only a preferred embodiment of the invention,

FIG. 1A is a side elevation of the intake assembly and support assembly.

FIG. 1B is a front elevation of the intake assembly and support assembly of FIG. 1A.

FIG. 2A is an end elevation of the intake tube.

FIG. 2B is a cross-section of the intake tube taken along the line B-B in FIG. 2A.

FIG. 3 is an end elevation showing the aluminium retaining washer used in the preferred embodiment to mount the intake to the intake port of the engine.

FIG. 4 is an elevation of the oil injunction tube.

FIG. 5 is a cross section of the carburetor boot.

FIG. 6 is a plan view of the carburetor plate.

FIG. 7 is a plan view of the support plate.

### DETAILED DESCRIPTION OF THE INVENTION

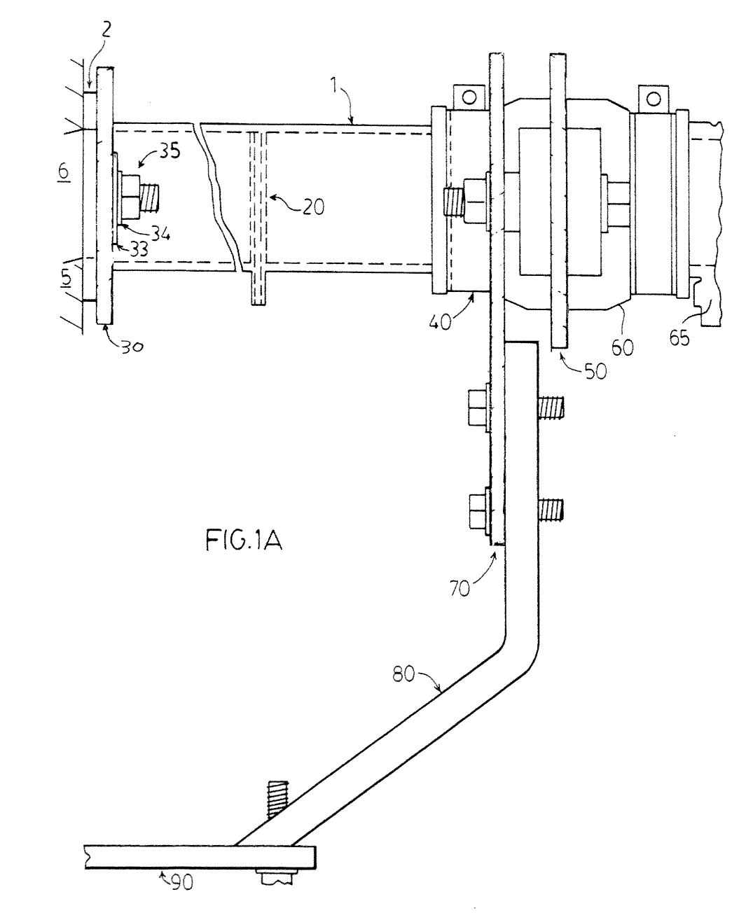

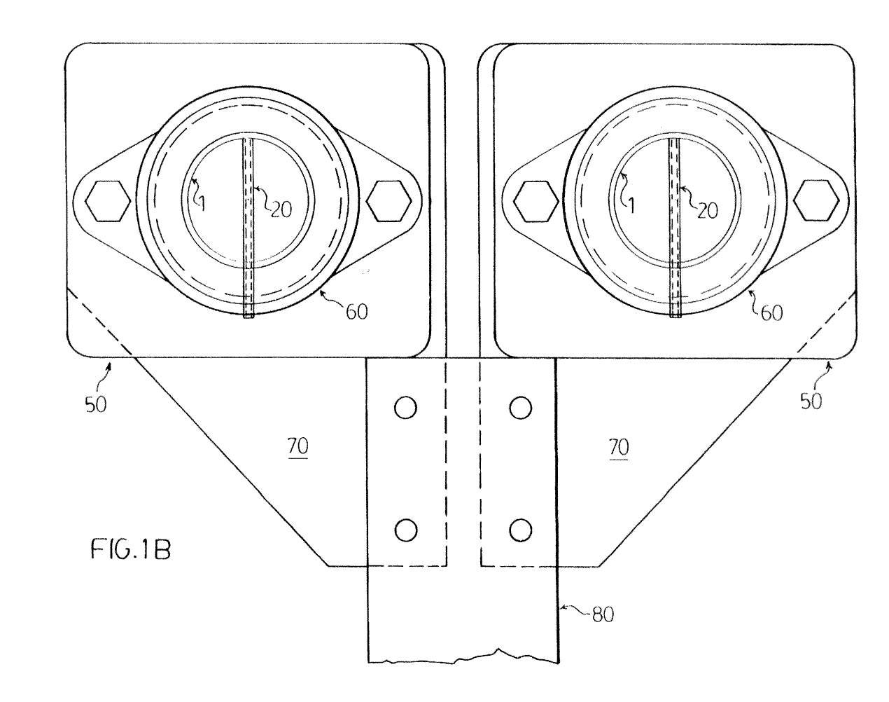

FIGS. 1A and 1B show a preferred embodiment of the intake assembly, including the intake tube 1, of the invention mounted to a two-stroke engine. For multi-cylinder engines, either identical tubes can be used for each cylinder or a distributor type arrangement can be employed where a single port at the carburetor is divided into separate tubes for each cylinder.

Generally, the intake tube 1 is a short straight tube connecting the carburetor directly to the engine. The thermal conductivity of the material, the length, diameter and thickness of the tube, and the thermal coupling of the intake tube 1 to the engine are selected to optimize the vaporization of the fuel-air mixture passing into the engine. Selecting the wall thickness of the tube is the preferred technique for optimizing the vaporization of the fuel-air mixture.

In the description that follows, the preferred embodiment will be described in the context of a 500 cubic centimetre (cc.) two cylinder piston ported two stroke engine with 250 cc. cylinder displacement per cylinder. However, it will be appreciated that the intake tube 1 of the invention can be used with other two-stroke engines and the invention is not intended to be limited to the particular embodiment shown and described herein by way of example.

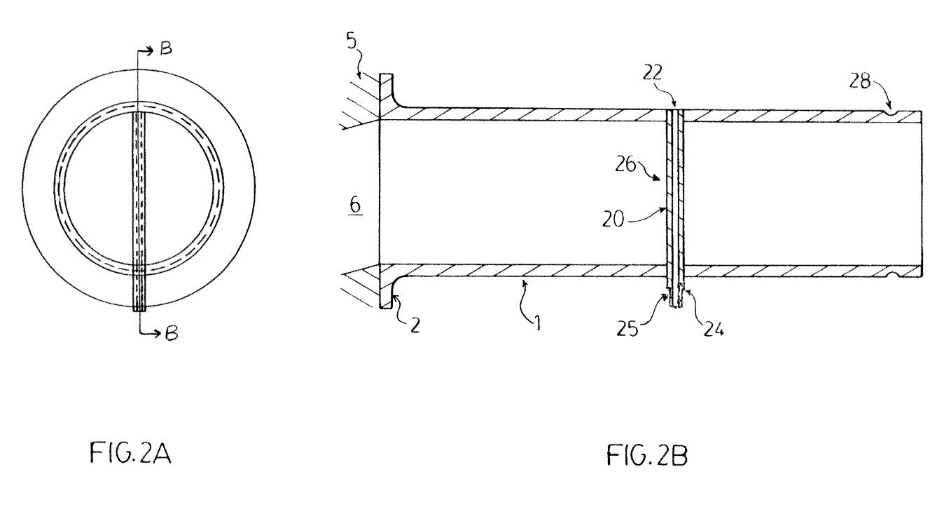

The intake tube 1 is illustrated in FIGS. 2A and 2B. In the preferred embodiment illustrated, the intake tube 1 of the invention comprises a tube approximately 5.5 inches long with a 1.4 inch inside diameter. The wall thickness of the tube is preferably 3/32 inches. The intake tube 1 has a flange 2 flaring outwardly at one end, preferably formed integrally with the intake tube, in thermal contact with the cylinder intake port 6. The flange 2 facilitates heat transfer between the engine 5 and the intake tube 1. In the embodiment shown, the diameter of the flange 2 at the engine is 2.25 inches. The flange provides a large surface area between the engine and the intake manifold to aid in heat transfer from the engine to the intake tube 1.

Disposed at an intermediate portion of the intake tube 1, preferably around the axial centre, is a copper oil injection tube 20 which extends through the intake tube 1 generally along a diameter (i.e. generally at the radial centre of the intake 1). The copper oil injection tube 20 may be installed substantially vertically within the intake I (when mounted) and flush with the outside diameter of the intake at the top 22. At the bottom of the intake, the injection tube 20 extends out of the intake by a short distance, for example about 0.375 inches. Alternatively, the injection tube 20 may extend only partially through the intake tube 1.

Referring to FIG. 4, the oil injection tube 20 in the embodiment shown is formed from a copper tube with an outside diameter of approximately 0.144 inches and an inside diameter of approximately 0.059 inches. It is silver-soldered to the intake tube 1 at the top 22, closing the upper end of the tube 20, and silver soldered to the intake at the bottom 24 to provide a seal between the wall of the intake tube 1 and the injection tube 20. At the centerline of the intake tube 1, a small orifice 26 is provided (for example drilled) through the wall the injection tube 20, preferably with a diameter of 0.044 inches. The orifice 26 is directed toward the flanged end of the intake tube 1 (that will be mounted to the engine 5).

At the bottom of the intake 24, the outside of the injection tube 20 preferably narrows as at 25 to facilitate coupling with an oil injection hose (not shown), preferably to an outside diameter of 0.125 inches to be compatible with a ⅛ inch or 3 mm oil injection hose (not shown). The oil injection hose is connected to the engine's oil injection pump (not shown). Oil can thus be pumped from the engine's oil injection pump, through the oil injection hose to the oil injection tube 20 and out the orifice 26 into the intake tube 1. It will be appreciated that providing the connection point to the oil injection hose at the bottom of the intake I is for convenience only and does not limit the positioning or orientation of the oil injection tube 20.

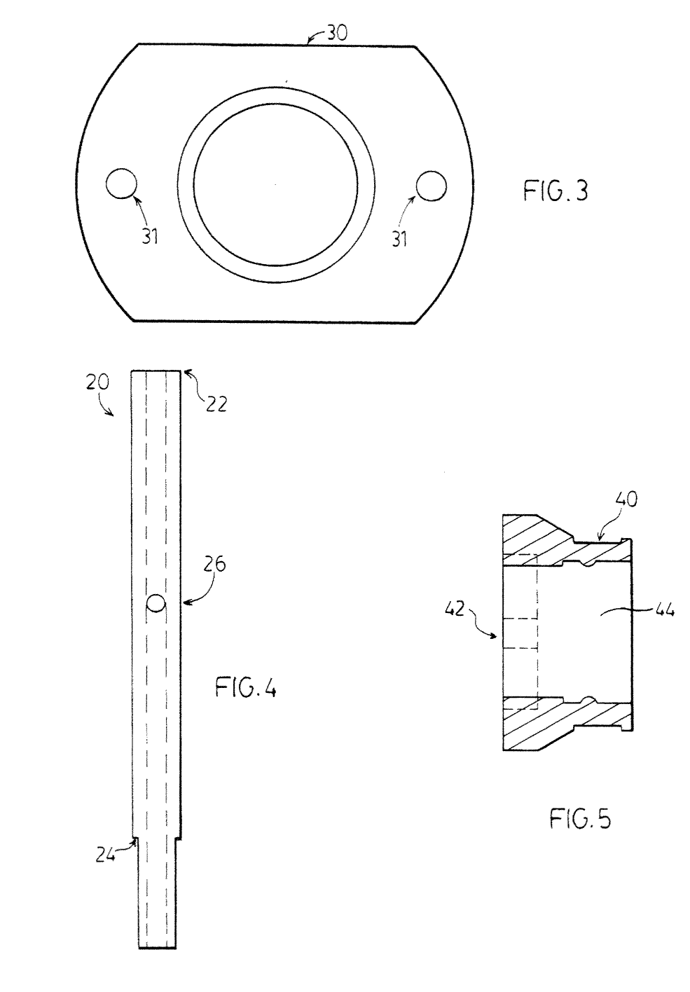

Referring to FIG. 3, the intake tube 1 is mounted on the engine using an aluminium washer 30, as can be seen in FIG. 1A. The washer 30 is installed over the intake tube 1 and is engaged to the flange 2. Bolts are disposed through holes 31 to secure the washer 30 to the engine The dimensions of washer 30 may be selected to match (or to be larger than) the flange of the intake 1, which as shown has a diameter of 1.635 inches. The washer 30 should preferably be less than 3/16 inch thick to prevent excessive heat retention by the aluminium washer 30. The dimensions of the washer 30 should allow some slight movement between the washer 30 and intake tube 1 to allow for differing rates and extents of thermal contraction and expansion between the palls. The washer 30 may be connected using two intake port studs 32 that are integrated with the engine 5. It will be appreciated that the means for attaching the intake tube 1, and washer 30 may depend on the arrangement and model of the engine. Each aluminium washer 30 is preferably mounted using a washer 33, a bowed spring washer 34 and a locking nut 35, such as that sold under the name Nylock®, as shown in FIG. 1A. The locking nuts 35 should preferably be tightened so that the spring washers are about ⅔ flat. The spring washer 34 is used to maintain pressure between the intake tube 1 and the engine 5 at different temperatures during engine operation. The joint between the intake tube 1 and the engine 5 should be able to slide to prevent galling of the surface or eventual cracking.

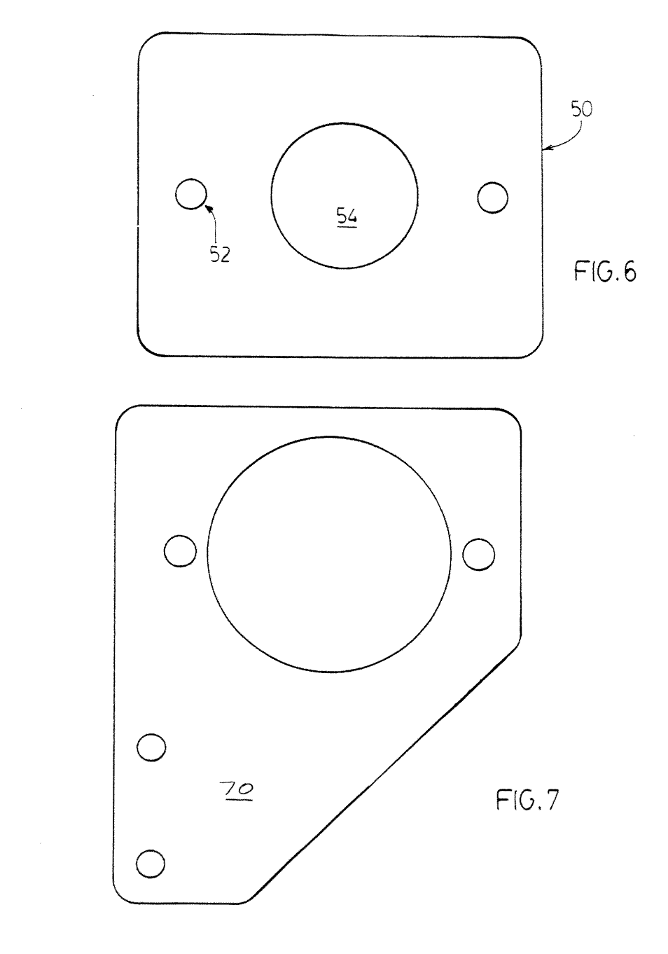

The end of the intake tube 1 opposite the flange 2 has a radiused undercut 28 which reduces the outside diameter of the intake tube 1 to a diameter of about 1.5 inches. A carburetor boot 40, such as the Mikuni® VM 34 rubber carburetor boot as shown in FIG. 5, is placed over the end of the intake tube 1 opposite the flange 2. The undercut 28 engages with the collar of a carburetor boot 40 to removably lock the carburetor boot 40 to the intake tube 1. The carburetor boot 40 is bolted, using bolt holes 42, to a carburetor plate 50, shown in FIG. 6, through bolt holes 52. The same bolts are used to bolt a second carburetor boot 60, which may be substantially the same as carburetor boot 40 but in a reverse orientation, to the first carburetor boot 40 through the carburetor plate 50. The second carburetor boot 60 is in turn attached to the engine carburetor 65. This assembly allows the intake tube 1 to be mounted to the carburetor while allowing the fuel mixture to pass from the carburetor through open centres 44, 54 in the pair of carburetor boots and the carburetor plate 50, respectively, into the intake tube 1. A fuel resistant silicone may be used to seal the carburetor boots 40. The inside diameter of intake tube 1, and the openings through carburetor boots 40 and carburetor plate 50, are preferably as large as the engine intake port and the passage through the carburetor so that the intake assembly of the invention does not substantially restrict the flow of fuel mixture to the engine and starve the engine of fuel. In the preferred embodiment, the inside diameter of the intake tube 1 is slightly larger than inside diameter of the carburetor port.

FIGS. 1 and 1B show the assembly connecting the carburetor 65 to the engine 5. Supporting plates 70 and supporting bracket 80 support the intake tube 1 on the engine base 90. The precise shape and arrangement of the supporting plates and brackets 70, 80 will depend on the design and shape of the engine as will be apparent to a person skilled in the art.

With reference to the above description, the following section describes how the inventor believes the invention works. However, this is only one theory which might explain the operation of the invention, and no representation is made that the operation is actually as described.

The general operation of the intake assembly I relies upon engine heat transferred by conductivity from the engine 5 to the intake tube 1 through the contact surface area between the engine 5 and the flange 2. The high thermal conductivity of the copper intake tube 1 allows the heat to transfer to the intake tube 1, exposing the fuel mixture with sufficient heat to homogenize the fuel droplets without substantially heating the fuel mixture temperature.. The length, diameter and thickness and other dimensions of the intake tube 1 are designed to vaporize substantially all of the fuel-air mixture before it enters the engine but not substantially heat the mixture. In the preferred embodiment, the primary factor is the wall thickness of the intake tube 1.

Preferably, in normal engine operation, the intake tube 1 will be substantially at the ambient temperature of the engine compartment and the fuel will be homogenized.

Further, heat from the intake tube 1, the oil injection tube 20 and the fuel-air mixture aids in the vaporization of the oil injected from the oil injection tube 20. The heat provided by the walls of the intake tube 1, the oil is at least partially vaporized and mixed with the fuel mixture. The main purpose of the oil injected into the fuel-air mixture is to lubricate the engine. In the experience of the inventor, less oil is required to lubricate an engine when the oil is vaporized.

As the atomized fuel mixture enters the intake tube 1, heat from the intake tube 1 vaporizes the mixture, especially around the circumference of the intake tube 1 interior, where the fuel mixture is in direct contact with the intake tube 1. As the fuel mixture approaches the copper oil injection tube 20, there is sufficient heat available to fully vaporize the remaining atomized fuel in the center of the intake tube 1. Further, the heat from the oil injection tube 20 itself may aid with vaporizing the fuel mixture along the axial centre of the intake tube 1. After passing the oil injunction tube 20, some heat may be transferred from the fuel mixture to the oil to vaporize the oil. It is desirable that all the heat that is transferred to the intake tube 1 be used in the vaporization process of the fuel mixture and oil, resulting in a minimal temperature increase of the fuel mixture.

In the preferred embodiment, the dimensions of the intake tube 1, including the length and thickness of the copper are designed so that the intake tube 1 remains at approximately the same temperature as the fuel-air mixture temperature entering the intake from the carburetor during most engine operating conditions.

Preferably, the fuel mixture is vaporized before the oil is introduced in the intake tube 1. In the inventor's experience, separate vaporizations of the fuel mixture and oil results in a more consistent vaporization over a variety of engine operating conditions.

The dimensions of the oil injection tube 20 are important so that the oil is not over heated. The thickness of the walls of the oil injection tube 20 and the size of the orifice 26 affect the rate at which the heat from the intake tube 1 is transferred to the injected oil. Since some heat is transferred to the oil, the viscosity of the oil is reduced and the orifice 26 may be made smaller. The size of the orifice 26 affects the rate at which oil is injected into the intake 1.

Further, the oil injection tube 20 must have a small outside diameter in relation to the inside diameter of intake tube 1, as mentioned above, so it does not cause undue turbulence in the flow of fuel mixture to the engine. Turbulence in the fuel mixture is undesirable and for two-stroke engines can interfere with the scavenging process to expel burnt fuel from the cylinder. Turbulence may cause inconsistent fuel atomization and or inconsistent control of fuel vaporization.

It will be appreciated that the use of an oil injection tube 20 may not be required in some embodiments of the invention. For example, a four stroke may not require oil injection and it is possible to pre-mix the oil with the fuel for use in a two stroke engine.

In the applicant's experience, the use of the invention in the preferred embodiment requires substantially less oil than the typical 50:1 fuel to oil mix and preferred operation uses a reduction in the oil injection ratio of approximately 35:1. The oil injection pump volume was also reduced to half from the stock 50:1.

Depending on the specific engine design, it may be necessary to modify the exhaust or ports of the engine to address overheating of the homogenized fuel mixture in the exhaust pipe before being drawn back in to the cylinder. Preferably, the exhaust ‘y’ pipe is extended between one cylinder exhaust port and the joint with the other cylinder exhausts.

Copper is used in the preferred embodiment because of its high thermal conductivity. In the preferred embodiment, tellurium copper alloy in particular is used because it is easier to machine than copper. A person skilled in the art will recognize that other metals and alloys with high thermal conductivity could be used, including plain copper.

Proper alignment of the intake tube 1 with the intake ports and the carburetor is important for smooth vibration free operation. As is known to someone skilled in the art, it may be necessary to make adjustments, including shimming and bracing, to the invention to allow vibration free operation and efficiency. Especially important to this invention is the contact between the engine 5 at the intake ports and the copper flange 2 of the intake tube 1. Proper contact is required for the thermal conductivity between the engine and the intake, therefore it is preferred that the intake ports and flange be machined flat and have a good flat surface.

Various embodiments of the present invention having been thus described in detail by way of example, it will be apparent to those skilled in the art that variations and modifications may be made without departing from the invention.

I claim:

1. An intake assembly, for use with a two-stroke internal combustion engine including a fuel-air mixing device comprising an outlet port and at least one cylinder comprising an intake port, said intake assembly comprising a thermally conductive intake tube comprising a first end for coupling in fluid communication with the fuel-air mixing device outlet port and a second end for coupling in thermal and fluid communication with the intake port of the at least one cylinder, for passing a fuel-air mixture from the fuel-air mixing device to the intake port of the at least one cylinder, whereby heat energy from the at least one cylinder heats the intake tube and the heat energy from the intake tube heats the fuel-air mixture passing through the intake tube to vaporize at least some non-vaporized fuel in the fuel-air mixture.

2. The intake assembly of claim 1, further comprising an oil injection tube for connection to an oil injection device, extending into the intake tube for introducing lubricating oil into the fuel-air mixture passing through the intake tube whereby at least some of the lubricating oil is vaporized in the intake tube.3. The intake assembly of claim 2 wherein the oil injection tube extends through the intake tube.

4. The intake assembly of claim 1 wherein the intake tube comprises a flange providing a surface area making thermal contact with the engine.

5. The intake assembly of claim 2 wherein the intake tube and the oil injection tube are made from the same material.

6. The intake assembly of claim 4 wherein the oil injection tube are made from copper.

7. The intake assembly of claim 5 wherein heat energy from the intake heats the oil injection tube and the heat energy from the injection tube heats the fuel-air mixture passing through the intake tube to vaporize at least some non-vaporized fuel in the fuel-air mixture from the fuel-air mixing device outlet port.

8. The intake assembly of claim 7 wherein the thickness of the tube wall and the position of the oil injection tube within the intake are selected to maximize the amount of fuel-air mixture vaporized.

9. The intake assembly of claim 1 wherein the temperature of the homogenized fuel mixture is maintained substantially the same as the temperature of the atomized fuel-air mixture.

10. The intake assembly of claim 1 wherein heat energy from the at least one cylinder homogenizes fuel droplets in the fuel-air mixture.

11. The intake assembly of claim 4 wherein the flange supports a washer for coupling the intake tube with the intake port of the at least one cylinder.
